(19) United States
(12) Patent Application Publication
(10) Pub. No.: US 2014/0019323 A1
(43) Pub. Date: Jan. 16, 2014

(54) PROCESSING OF ELECTRONICALLY TRADED FIXED-INCOME SECURITY BASED FUNDS

(71) Applicant: Cary J. BLAKE, Toronto (CA)

(72) Inventor: Cary J. BLAKE, Toronto (CA)

(73) Assignee: ROYAL BANK OF CANADA, Montreal (CA)

(21) Appl. No.: 13/475,407

(22) Filed: May 18, 2012

Related U.S. Application Data
(60) Provisional application No. 61/487,951, filed on May 19, 2011.

(51) Int. Cl. G06Q 40/04

(52) U.S. Cl. CPC G06Q 40/04
USPC 705/37

(57) ABSTRACT

Methods, systems, apparatus, and programming product for creating, maintaining, and otherwise administering new types of fixed income benchmarks and exchange-traded funds. Such benchmarks can be defined and/or occasionally, continually, or periodically redefined by the inclusion of instruments such as new bond issues as they are issued, reweighting of mixes of bond issues used in defining the benchmark(s), and/or removal of bond issues used in such definition, without other changes to the fund(s) and/or benchmark(s). Such benchmark(s) can also be modified through controlled or otherwise selective modification of characteristics used to define the benchmark(s), such as yield to maturity (YTM), maturity date, coupon value, and par value of the aggregated fund(s).

### TECHNICAL FIELD

The present disclosure relates generally to systems, devices, networks, methods, and machine-interpretable programming and/or other instruction products for the processing of data and other signals. In particular, the disclosure relates to computer processing and communication systems adapted for the creation, administration, and networked execution of processes representing the trading of funds based on pools of corporate, municipal, and/or other bonds, or other interest-bearing securities.

Aspects of the material disclosed in this application relate to the holding, transfer, and/or administration of securities and other financial interests. Aspects of such holding, transfer, and/or administration may be subject to regulation by governmental and other agencies. The disclosure herein is made solely in terms of logical, practical, economic, and communications possibilities involved with the implementation of systems useful in enabling such holdings, transfer, and/or administration, without regard to statutory, regulatory, or other legal considerations. Nothing herein is intended as a statement or representation that the making, use, or other application of any system, method or process proposed or discussed herein does or does not comply with any statute, law, regulation, or other legal requirement in any jurisdiction; nor should it be taken or construed as doing so.

### BACKGROUND AND SUMMARY OF THE INVENTION

In view of the very wide variety and complex nature of modern financial interests and markets and means for trading them, the bulk of transactions in financial interests are conducted electronically, using sophisticated distributed processing systems and communications networks. The reliance of most traders on such systems presents both many advantages and many challenges.

The disclosure herein relates to the application of such systems and networks, together with specialized processing techniques, to create, administer, and control trading related to exchange traded funds, or ETFs. ETFs are a particular class of financial interests that have both benefited from the advantages offered by high-speed automatic data processing systems and distributed computer networks, and faced challenges associated with such systems and networks.

In various aspects, the disclosure herein teaches methods, apparatus such as communication networks and data processors, programming product, and stored data sets useful in the processing of data related to the creation and administration of benchmark indexes (the ‘Benchmark’), that may be used in the creation, administration, and trading of exchange traded funds (ETFs), mutual funds, and other funds based on pools of securities such as corporate, municipal, provincial, federal and/or other bonds, or other interest-bearing and/or fixed-income instruments.

For example, in various aspects the disclosure provides means including methods, systems, apparatus, and programming product for creating, maintaining, and otherwise administering new types of fixed income benchmarks useful in the creation, administration, evaluation, and trading of new types of fixed-income based ETFs, mutual funds, and other financial interests or assets which may be bought or sold electronically via, for example, public or private communication systems. Such benchmarks can be defined and/or occasionally, continually, or periodically redefined by, for example, the inclusion of instruments such as new bond issues as they are issued, reweighting of mixes of bond issues used in defining the benchmark(s), and/or removal of bond issues used in such definition, without other changes to the fund(s) and/or benchmark(s). Such benchmark(s) can also be modified through controlled or otherwise selective modification of characteristics used to define the benchmark(s), such as yield to maturity (YTM), maturity date, coupon value, and par value of the aggregated fund(s).

As a further example, in various aspects the disclosure provides methods, apparatus, and programming products for the creation, administration, and trading of funds that may be defined, re-defined (e.g., rebalanced) or otherwise modified, evaluated, traded, and otherwise exploited wholly or partly through the use of such benchmarks. Such funds may, for example, be rebalanced by varying the identity(ies) and/or absolute or relative amounts of various interests or assets, such as fixed-income securities, used to define the funds, so as to conform to, or to acquire or otherwise assume one or more defined relationship to corresponding benchmark(s). In doing so, new or other additional bond or fixed-income issues can be added to a fund, existing issues removed from a fund, and/or existing issues reweighted within a fund through a rebalancing process conditioned upon maintenance of any one or more of such parameters at the same level(s); at the same or an improved level(s); or at a level that has not changed by more than a predefined threshold or tolerance, or limit.

As a further example, in various aspects the disclosure provides methods, apparatus, and programming products for the creation, administration, and trading of funds that may be defined, re-defined (e.g., rebalanced) or otherwise modified, evaluated, traded, and otherwise exploited wholly or partly through the use of such benchmarks. Such funds may, for example, be rebalanced by varying the identity(ies) and/or absolute or relative amounts of various interests or assets, such as fixed-income securities, used to define the funds, so as to conform to, or to acquire or otherwise assume one or more defined relationship to corresponding benchmark(s). In doing so, new or other additional bond or fixed-income issues can be added to a fund, existing issues removed from a fund, and/or existing issues reweighted within a fund through a rebalancing process conditioned upon maintenance of any one or more of such parameters at the same level(s); at the same or an improved level(s); or at a level that has not changed by more than a predefined threshold or tolerance, or limit.

As a further example, in various aspects the disclosure provides methods, apparatus, and programming products useful in the conditional rebalancing of funds, and benchmarks used to define, modify, evaluate, trade, and/or otherwise administer such funds. Such conditional rebalancing processes can, for example, include adding new or other additional bond or fixed-income issues, or other assets, to a fund and/or benchmark definition, removing issues or other assets used to define an existing fund and/or benchmark, and/or by changing the relative weights, or proportions, of such assets within the fund or benchmark so as to accomplish a desired effect on the benchmark(s) or fund(s).

For example, one or more funds may be created, based on grouping(s) of fixed-income securities, using benchmark(s) calculated by an administrator, broker, or one or more third party(ies), such as for example a stock exchange or bond market. Such fund(s) can be defined to have characteristics of traditional funds, and as well the characteristics of individual bonds (e.g., a single interest rate, coupon payments, and maturity date upon which total is paid back to owner). It can be advantageous for such a fund to have as many characteristics of an individual bond issue, (or other interest or asset), as possible. For example, the fund can be designed to mature, or otherwise terminate, at a specific point in time, at which owners will be paid their remaining ‘principal’; in the meantime they may receive ‘coupon’ or other period or intermediate payments. Purchasers of such funds often seek certainty and safety in returns; funds according to the disclosure herein can provide significantly more certainty than known funds, which tend to fluctuate with the economy, the outlook for the general level of interest rates the success of aggregated individual issuer's business, etc, without the certainty of the ‘coupon’ or ‘principal’ payment.

For example, a benchmark or fund can initially be defined by any one or more data processing system(s) and/or separately-controlled data source(s) to be based upon or include a desired number (e.g., 40-50) bond issues. While holding the initial bond mix throughout the life of the fund will typically give a good degree of certainty for prospective purchasers, it may be advantageous for an issuer/administrator of such a benchmark or fund to retain the flexibility to add new issues as they arise. Such ability can help, for example, with diversification of the fund (and therefore minimize associated risk(s)), increase the income-generating capacity of the fund, and allow more flexible strategies for both purchasers and administrators. Such ability can also be used to improve liquidity in secondary markets.

Addition of new bond issues, with resultant improvements in risk and income generation, can be accomplished through the use of ‘conditional rebalancing’ techniques as described herein. Some parameters of a benchmark and/or fund, such as for example its income and/or credit profile, may be held constant, or within a specified tolerance, or required to improve as result of the addition of new issues, or rebalancing of the issues.

Advantages offered by funds according to various aspects of the disclosure include consistent benchmark performance, which can be attractive to purchasers in both primary and secondary markets. Purchasers in primary markets, for example, often seek diversified replacements to single-issue purchases. By definition, the characteristics of such individual issues do not change, and it is believed that in many cases investors will find similar properties attractive in an ETF or other fund. However, traditional bond indices and funds do not deliver a profile consistent with this requirement.

Further advantages can include performance of such funds during periods of expansion and/or contraction in credit spreads. For example, during periods of contraction in credit spreads, where for example spreads related to BBB-rated issues may compress more markedly than those associated with other classes of bonds, new additions can be bullet-like in terms of credit quality—i.e., new issues with high- to mid-quality credit ratings can be favored, with a resultant improvement in average or aggregate spread or YTM while maintaining the aggregate credit quality of the fund.

The disclosure further allows ETFs to be tailored for convexity, which is is a measure of the sensitivity of fixed income instrument to changes in interest rates. Convexity may be defined as the sentivity of a bond's duration to changes in interest rates. In general, the higher the convexity, the more sensitive the bond's duration is to the change in interest rates.

Conversely, at times of expanding YTM spreads, where for example BBB-rated issues in particular are rising sharply, additions may be barbelled in terms of credit quality—i.e., addition of BBB-rated issues may be favored, with resultant improvement in the aggregate or average spread or YTM, while maintaining the aggregate credit/risk quality of the fund.

In various embodiments, the invention provides methods and further components, including software, for implementing the various functions and processes described herein.

In further embodiments, the invention provides funds created, maintained, offered, and traded in accordance with the disclosure.

### BRIEF DESCRIPTION OF THE DRAWINGS

The invention is illustrated in the figures of the accompanying drawings, which are meant to be exemplary and not limiting, and in which like references are intended to refer to like or corresponding parts.

FIG. 1 shows an example of a system suitable for processing data related to the creation, administration, and trading of electronically-traded funds in accordance with aspects of the disclosure.

FIG. 2 is a schematic flow diagram illustrating an example of a conditional balancing process implemented by in applying rules of creating and administering benchmarks and/or funds in accordance with the disclosure.

FIGS. 3A and 3B are schematic tabular diagrams illustrating processes useful in applying rules of creating and administering benchmarks and-/or funds in accordance with the disclosure.

FIG. 4 is a tabular representation illustrating application of processes according to the disclosure on a benchmark and fund defined in accordance therewith.

### DETAILED DESCRIPTION OF THE PREFERRED EMBODIMENTS

Preferred embodiments of methods, systems, and apparatus according to the invention are described through reference to the drawings.

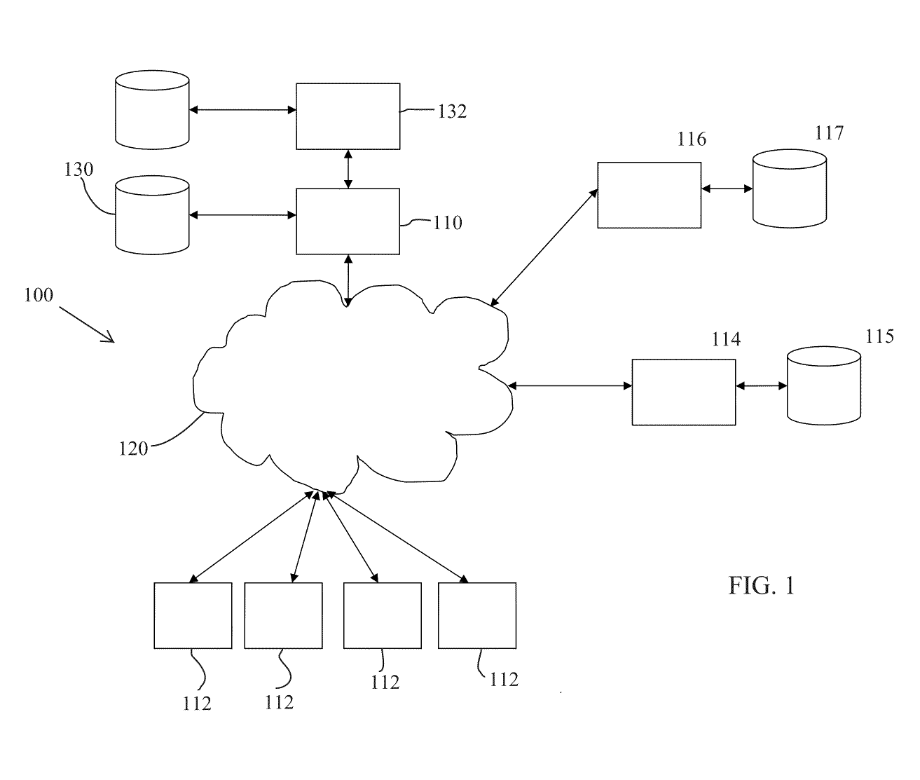

FIG. 1 shows an example of a system 100 suitable for collecting, assessing, processing, and disseminating data related to the creation, administration of benchmark indexes and/or execution of trades relating to exchange traded funds, mutual funds, and/or other funds in accordance with various aspects of the disclosure. In the example shown, system 100 includes one or more benchmark and/or fund systems 110 and optionally one or more trader or investor systems 112, third-party data source systems 114, and/or electronic exchanges 116, and respective related database systems 115, 117. In various embodiments, benchmark and/or fund system(s) 110 may communicate with trader or investor system(s) 112 data source(s) 114, and/or electronic exchanges 116 directly (e.g., through private local- or wide area network(s) or other secure wireless or wireline communication), indirectly, and/or remotely, e.g., via the Internet or other public wide-area or other networks 120. In preferred embodiments, communications between the various components of system 100 are effected using coded, optionally encrypted, electronic signals.

In the example shown, benchmark and/or fund system(s) 110 are responsible for any or all of creating, administering, trading and/or otherwise controlling benchmarks and/or funds created in accordance with the disclosure. For example, using data input acquired from various local and/or remote user systems, system(s) 110 can access and apply stored and/or specially-created logic rules to create, store, and otherwise process data representing one or more benchmark fund products for sale to primary and/or secondary market participants through, for example, communications between system(s) 112 and benchmark and/or fund system(s) 110.

Systems 110 can further optionally control or otherwise accommodate (e.g., facilitate) data processes representing trades of such funds to or between such users. In particular, system(s) 110 can apply logic rules adapted to implement conditional rebalancing processes as described herein. In so doing, system(s) 110 can operate alone and/or in combination with one or more third-party electronic exchanges 116.

In various embodiments, benchmark and/or fund system(s) 110 can use data supplied by one or more local or otherwise directly-related (or commonly-controlled) administrative systems 132, and/or by third-party (e.g., independently-controlled) data source(s) 114, in identifying securities issues to be added to a benchmark and/or fund, either at time of creation or thereafter; and/or in otherwise creating or applying rules of conditional rebalancing as described herein.

Trader or investor system(s) 112 may comprise any one or more input and communications devices suitable for generating and/or otherwise providing inputs suitable for the purposes described herein.

In various embodiments, any or all of benchmark/fund system(s) 110, investor system(s) 112, data source system(s) 114, and/or electronic exchange(s) 116 may be implemented on or otherwise include one or more systems of any type(s) suitable for creating and/or administering or evaluating benchmarks, and/or controlling evaluation and/or trading of funds in accordance with the disclosure. In particular, for example, any such system(s) may comprise one or more desktop, server-class, and/or dumb terminal systems, and/or larger, multi-component systems comprising public or private networks such as LANs or WANs. Further, such systems (and particularly trader or investor systems 112) may be implemented wholly or partially using mobile devices such as cell phones, multi-purpose palmtop devices, tablet-type computers, etc.

Moreover, any or all of system(s) 110, 112, 114 may be implemented as separate system(s), as shown, or they may be provided in any suitable combination(s) on single systems using appropriately-configured input and output devices, including any suitable access authorization systems or features for allowing controlled whole or partial system access to multiple users using the system(s) for different purposes. As will be appreciated by those skilled in the relevant arts, once they have been made familiar with this disclosure, a very wide variety of computers and/or other data processing systems and architectures, many know known and commercially available, and doubtless others yet to come, are suitable for use in implementing the systems, methods, etc., disclosed herein.

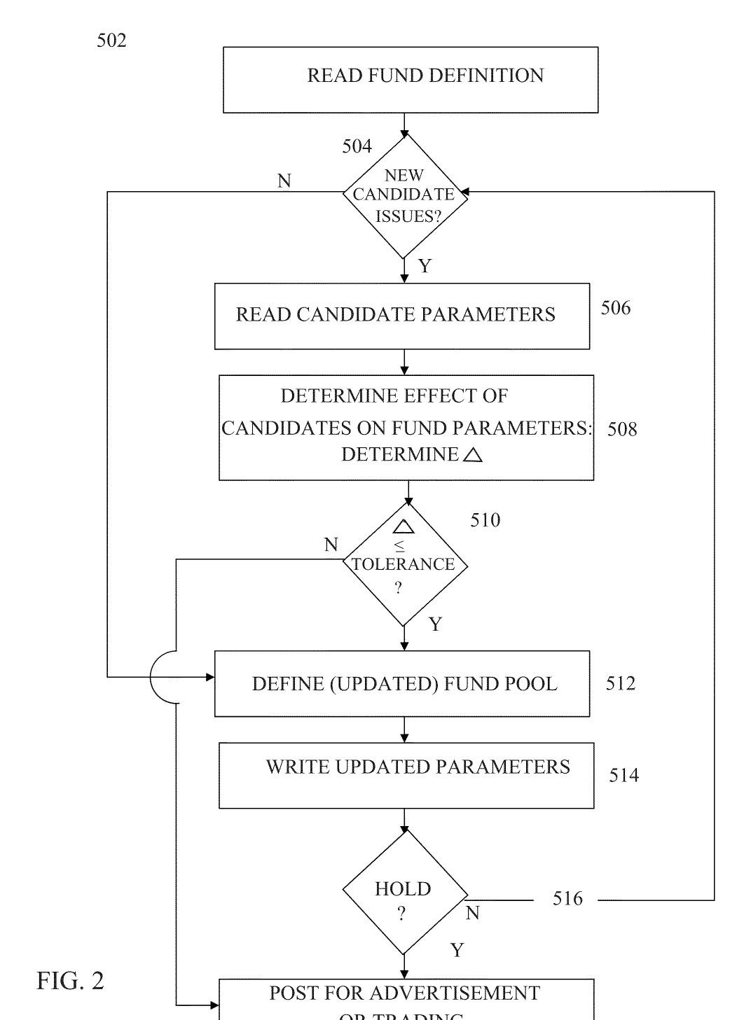

FIG. 2 is a schematic flow diagram illustrating an example of a data process 500 suitable for use by, for example, a system 110 in applying coded, machine-readable rules, or logic, for creating and administering benchmarks and/or funds in accordance with the disclosure. In particular, process 500 of FIG. 2 may advantageously be used for fully- or semi-automated conditional re-balancing of a fund created, administered, and traded in accordance with the disclosure. Various embodiments of process 500 are suitable for implementation using systems such as that shown in FIG. 1, or any of a wide variety of variations thereof, ranging from single desktop, palmtop, or other small systems to widely dispersed, redundant, networked systems, applying suitably-configured hard-wired and/or otherwise encoded logic rules.

At 502 system 110 can access data useful for defining, or otherwise identifying, a benchmark or exchange traded fund to be created, re-balanced or otherwise administered, and/or traded in accordance with the disclosure. For example, a processor associated with the system 110 can access a database 130 associated with the system 110 to read or otherwise retrieve (i.e., pull) suitably-configured data. Alternatively, suitable data may be pulled and/or pushed from non-commonly-controlled system such as 114, 116, and/or 112, via a communications network.

For example, one or more funds may be created, based on fixed-income securities, using benchmarks calculated by one or more party(ies), including for example a stock exchange, using, for example one or more third-party system(s) 114 as shown in FIG. 1. Such funds can be defined to have characteristics similar to those of traditional funds, and/or characteristics of individual bond or security issues (e.g., a single interest rate, coupon payments, and maturity date upon which total is paid back to owner, in replication of a real or idealized bond or security). As noted above, it can be advantageous for such a fund to have as many characteristics of an individual bond issue as possible. For example, a fund can be designed to terminate at a specific point in time, at which time owners will be paid any remaining ‘principal’; in the meantime ‘coupon’-type payments can be generated. Purchasers of such funds often seek certainty in risk and timing of payment(s); among other benefits, funds according to the disclosure herein can provide significantly more certainty than known funds, which tend to fluctuate with the economy, the outlook for the general level of interest rates the success of the aggregated individual issuer's business, etc, without the certainty of the timing or amount of ‘coupon’ or ‘principal’ payments.

For example, data representing a benchmark and/or fund in accordance with the disclosure can initially be defined, by any one or more of system(s) 110 and/or data source(s) 114, to include 40-50 bond issues. While holding the initial bond mix will typically give an acceptable degree of certainty for prospective purchasers, it may be advantageous for the issuer/administrator of such a benchmark and/or fund to retain the flexibility to add new issues as they arise. Such ability can help, for example, with diversification of the fund (and therefore with minimization of associated risk(s)), increase the income-generating capacity of the fund, and allow more strategic flexibility for both purchasers and administrators. It can also improve liquidity in secondary markets.

In various embodiments, the ability to add such new issues through automated or semi-automated conditional rebalancing processes described herein can be particularly advantageous in applying the techniques described herein for improving the trading of interests through, for example, electronic processing of data representing transactions in corresponding exchange-traded funds. As those familiar with electronic trading and the dissemination of information relating to financial interests will understand, the creation and administration of such funds in general can be significantly enhanced by providing suitably-coded instruction sets to system(s) 110, so as to cause such benchmarks and/or funds, and related information, to be monitored continuously, or continually, using automated data processing techniques.

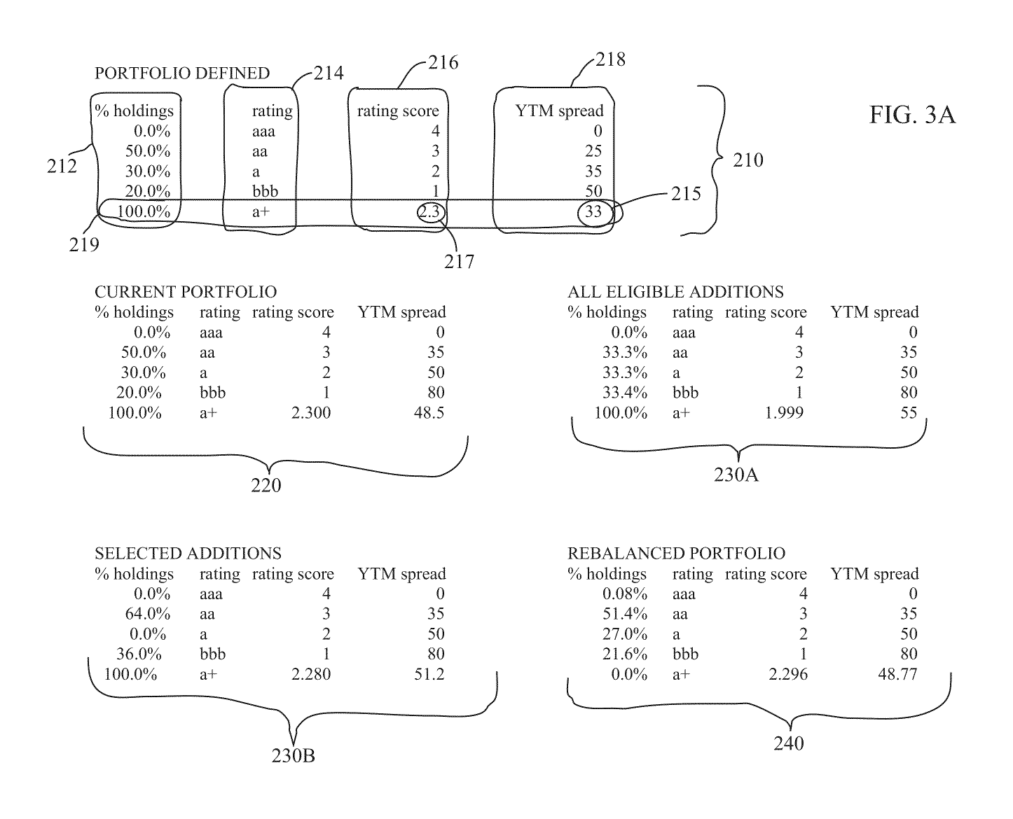

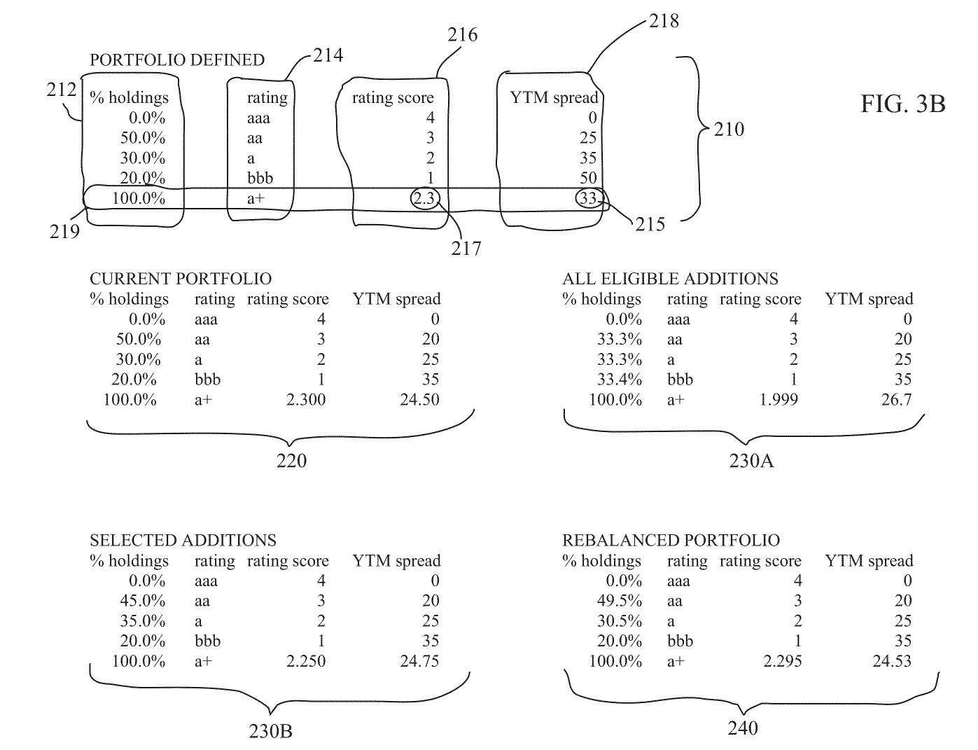

FIGS. 3A and 3B are schematic diagrams useful in illustrating processes used in applying logic rules for creating and administering benchmarks and/or funds in accordance with the disclosure.

At 210, FIG. 3A shows a summary data useful for defining, or otherwise creating or identifying, a target or initial portfolio definition for a bond-based benchmark and/or fund in accordance with the disclosure. Summary 210 summarizes data useful for defining target or initial parameters to be used in creating and/or maintaining the portfolio. The data shown at 210 can, for example be accessed by one or more processors associated with a system 110 by use of read input processes directed toward database 130 associated with the system 110. Alternatively, such data could be routed to the system 110 from any one or more of systems 112, 114, 116.

In the example shown, parameters represented by data accessed by system 110 include data representing target holdings percentages 212 indicating a range and balance of types and qualities of securities to be included in the portfolio; credit ratings 214 associated with the securities and corresponding credit rating scores 216; and yield-to-maturity (YTM) spreads 218.

Any or all of parameters 212, 214, 216, 218, etc., may be defined and/or modified by, for example, one or more users of administrator system(s) 132, using suitably-adapted data input/output processes. Data accessed by system 110 at 502 can, for example, be represented by one or more data records formatted as:
<start><fund identifier><pct holding 1><rating 1><score 1><YTM 1>
   <pct holding 2><rating 2><score 2><YTM 2>
   <pct holding 3><rating 2><score 3><YTM 3>
   <pct holding 4><rating 4><score 4><YTM 1>
<pct holding Aggr.><rating Aggr.><score Aggr.><YTM Aggr.><end>,
   where:
<start>=a functional header flagging beginning of a defninitional data string
<fund identifier>=a coded character sting representing a unique fund name
<pct holding n>=the percent of the fund to be constituted by the nth class of holdings
<rating n>=the credit rating associated with class n of the fund holdings
<score 1>=the risk rating score associated with class n of the fund holdings
<YTM 1>=the YTM spread associated with class n of the fund holdings
<end>=a functional trailer indicating end of definitional data string
   and
n=the number of different classifications to be used in identifying suitable interests considered for inclusion in the fund, and
Aggr. indicates characteristics associated mean or other aggregated values of parameters of the fund as a whole

Target holdings percentages 212 can define a target or initial range and balance of securities classes to be included in the portfolio. In the example shown, four classes (sometimes called “buckets”) of bonds are defined as potentially includable in the portfolio: these range, as shown at 214, from class AAA bonds to class BBB bonds, in defined percentages of the total portfolio. In the example shown, the benchmark and/or fund is initially to consist of, or be defined by, 50% class AA bonds, 30% class A bonds, and 20% class BBB bonds (so that, as shown at 219, 100% of the portfolio is defined by those three classes). Any desired or otherwise suitable mix of classes may be defined. In various embodiments of the invention, percentages assigned to or otherwise associated with the individual classes may be varied during the life of the benchmark and/or fund, if for example other characteristics of the fund are to be defined as controlling. In other embodiments, such percentages may be fixed at the creation of the benchmark and/or fund, or at any suitable or desirable time thereafter.

In many embodiments, the mix of securities to be included in a benchmark and/or fund in accordance with the disclosure is defined to include only bonds or other fixed-income securities having a common maturity date or duration, or maturity dates or duration set within a determined range (such as one month) of each other. This common maturity date or duration (or maturity date range) can be set at the creation of the benchmark and/or fund, and can be maintained throughout the life of the benchmark and/or fund, such that the benchmark and/or fund has from the start a consistent maturity date.

Commonality of further factors, such as timing of coupon payments, can also be enforced, both at the beginning and/or as a fund matures.

The assignment and/or maintenance of common maturity dates, coupon payment schemes, etc., can for example help to define a fund product that looks and behaves in many respects like a single bond issue, which effect can attract some investors.

Ratings 214 shown in FIG. 3A indicate bond or securities ratings to be associated with each particular class of bonds. Where used, ratings 214 can be derived from any existing source(s) (e.g., Moodys, Standard & Poor, Dun & Bradstreet), and/or defined by the administrator(s) of system 110).

Rating scores 216 can provide numerical or other values usable by system(s) 110 in calculating portfolio target averages, or other aggregated or collective values, in defining and maintaining the desired characteristic(s) of a benchmark and/or fund. In the example shown, the selected percentages defined at 212 corresponding to the three classes AA, A, BBB shown at 214, are assigned scores of 3, 2, and 1 points, respectively. When combined in the percentages shown at 212, these score assignments provide a target aggregate or average score 217 of 2.3 useful for identifying bond issues to be included in the benchmark and/or fund:

((0.5*3)+(0.3*2)+(0.2*1))/1.0=2.3

Defining a target or initial rating score 217 of the benchmark and/or fund of 2.3 (or any other value) means that, in order to be included in the benchmark and/or fund, a prospective new issue or combination of issues must be added in quantities, which may be expressed in terms of relative and/or absolute numbers, that do not cause the resultant aggregate or average rating of the benchmark and/or fund to deviate from the target rating by more than a pre-determined threshold or tolerance amount, the absolute value of which may be greater than or equal to zero.

The yield to maturity (YTM) of a bond represents the rate of return to be earned by a holder of the bond, assuming that the bond is held until maturity, and that all coupon and principal payments are made on schedule. It can be used as a measure of estimation of future return, and is, with credit rating, typically one of the principal considerations used by an investor in comparing the merits of different financial instruments.

In the example shown, YTMs 218 indicate target or initial average spreads, expressed in basis points, of bonds to be included in the various classes of bonds to be used in defining the benchmark and/or fund. For example, as shown in FIG. 3A, the average YTM of class AA bonds to be included in the benchmark and/or fund described by summary 210 is to be enforced at a target spread of 25 basis points (or within a specified variation of that target); class A bonds an average spread of 35 basis points; and BBB bonds an average spread of 50 basis points. Applied to the distribution defined at 212, 214, this provides a target average spread 215 of 33 basis points for the defined ETF:

((0.5*25)+(0.3*35)+(0.2*50))/1.0=33

Thus, as shown at 219, in the example shown the benchmark and/or fund defined by summary 210 consists of 50% class AA bonds, 30% class A bonds, and 20% class BBB bonds, with a target rating score 217 of 2.3 and a target YTM spread 215 of 33 basis points. Alternatively, an absolute level of YTM can be used as a substitute to the credit spread.

Any or all of target percentages 212, and/or any of parameters 214, 216, 218, and/or any other suitable parameters used to define a fund, may, within for example the limits of mathematical possibility, be defined as fixed or floating. When any one or more such parameters are defined as fixed, then, as specific issues are considered for addition to the portfolio, a determination may be made by benchmark and/or fund system(s) 110 as to whether addition of the new issue(s), reweighting an existing issuer, or removal of an existing issue will cause any or all of parameters 215, 217, and/or any other desired parameters to (a) remain the same (absolutely or within one or more predetermined tolerance ranges); (b) increase (optionally within a tolerance), or (c) decrease (optionally within a tolerance. The projected result of addition of such issue(s) can be can be compared with criteria (i.e., conditions) specified for example in summary 210, and a determination made whether to add or not to add the new issues, add a portion of the new issues, reweight existing issues or remove an existing issue from the benchmark and/or the fund.

Parameters defined as floating may be allowed to vary freely when issues are added to the portfolio, or may be allowed to vary within relatively broader limits than those defined for fixed parameters. Thus various levels of tolerance may be defined for different parameters.

Such consideration of the effect of addition of new issues, reweighting of existing issues or removal of an existing issue, and the determination whether to add such new issues, reweight existing issues or remove existing issues based on application of conditions specified for example at 210, can be referred to as conditional rebalancing of the benchmark and/or fund.

An example of conditional rebalancing of a bond-based benchmark and/or fund in accordance with the disclosure is described by reference to steps or blocks 504-516 of FIG. 2, and summaries 220, 230A, 230B, 240 of FIG. 3A. It is noted that upon establishment of desired parameters as shown at 210, a new fund may be established by applying the “rebalancing” process of 504-516.

At 504 in FIG. 2 a determination is made as to whether any new issues are available that may be considered candidates for inclusion in the fund established or accessed at 502. Such determination may be made by considering all new issues of interests in the general class selected to constitute the fund (e.g., all new-issue corporate bonds with a credit rating equal to or higher than BBB), or through the use of any desired pre-review vetting process(es).

According to one example, a conditional rebalancing process for determining whether one or more new issues should be added to a benchmark and/or a fund can begin with calculation of various current characteristics of the pool constituting the benchmark or fund.

For example, the current relative contribution of each issue comprised by the fund (or benchmark) to one or more of the characteristics of the fund may be determined. Such determinations may be based on the contribution of each issue or class of instruments to any desired characteristic of the fund, including for example the value of the fund (or benchmark), either by par or market value. Such a determination may, for example be made thus:

relative weight (issue i)=value contributed by (issue i)/total value of fund,

where “i” indicates the ith issue (e.g., separate CUSIP instrument, and i varies between 1 and m); and “value” is the total value, par or market, of that portion of the fund or benchmark contributed by the ith issue. The relative value (or percent composition, etc.) of each issue may be referred to as its relative weight within the fund or benchmark.

Next, the initial or otherwise current aggregate, weighted values of each of the following fund/benchmark parameters may be determined for the fund, prior to addition of any new issues:

Initial value 1=YTM

Initial value 2=credit rating (converted to numerical values)

Initial value 3=coupon value

Initial value 4=duration or convexity

Initial value 5=any other desired fixed-income characteristic(s)

For example, for a fund/benchmark currently defined on the basis of four issues, in the following relative weights, by value or other measure:

Issue A=35% of fund and is associated with a YTM value “YTM A”

Issue B=30% of fund and is associated with a YTM value “YTM B”

Issue C=15% of fund and is associated with a YTM value “YTM B”

Issue D=20% of fund and is associated with a YTM value “YTM B”

Then the weighted aggregate YTM of the fund/benchmark may be determined as follows:

Aggregate weighted YTM=0.35*YTM A+0.3*YTM B+0.15*YTM C+0.2 YTM D

When the existing aggregate fund characteristics have been determined, then at 506 data representing relevant parameters, or characteristics, of each of the new issue candidates may be read. In the example described above, for example, in which the fund was established based on credit ratings, risk scores, and yield to maturity associated with a group of bonds, records identifying a number m of new bond issues might be read and stored in volatile or persistent memory accessible by the processor(s) of system 110, thus:

<CUSIP 1><YTM 1><credit rating score 1><coupon value 1><duration 1>

<CUSIP 2><YTM 2><credit rating score 2><coupon value 2><duration 2>

<CUSIP 3><YTM 3><credit rating score 3><coupon value 3><duration 3>

<CUSIP 4><YTM 4><credit rating score 4><coupon value 4><duration 4>

<CUSIP 5><YTM 5><credit rating score 5><coupon value 5><duration 5>

where:

<CUSIP m>=a unique identifier for the mth new issue of the bond

<credit rating score>=a numerical value assigned to a specific credit rating

At 508, the effect of possible addition of each new issue on the fund or benchmark may be assessed, and a determination made whether it is desirable, or possible, to add it to the existing fund pool. Candidates may be assessed on either an issue-by-issue or amalgamated basis.

The determining the effect of adding an issue can start with a determination of the relative weight of each new issue, if it were to be added to the fund. Again, such relative weight may for example be based on either par or market value of the issue being considered.

Then, using the relative weight of the candidate new issue, the effect of the proposed addition on each parameter of interest may be determined. A number of criteria may be used in making such determination. For example, a new issue may be added to the fund if:

New weighted aggregate Value 1>Initial Value 1

New weighted aggregate Value 2>Initial Value 2, etc.

Alternatively, depending upon the nature of the Value and its relative numerical scoring, an issue may be added if the new weighted aggregate value is less than, or equal to, the initial value.

As a further alternative, a new issue may be added if the change in aggregated value that would result is greater (or lesser) than the initial amount by a predetermined threshold amount, or limit, which may be stated in absolute terms, such as an absolute difference in par value; or relative terms, such as a percentage of the original aggregate value. For example, an issue might be added if:

(New weighted aggregate value−Initial value)/Initial Value

is less than or equal to (or greater than or equal to) a predetermined percentage.

As an example, at 220 in FIG. 3 the effect of addition of new issues to an existing fund is assessed by first calculating the characteristics of the existing benchmark or fund. At 220 a summary of parameters for a bond-based benchmark and/or fund is provided. As shown, the benchmark and/or fund consists or is intended to consist of 50% class AA bonds having a YTM spread of 35 basis points; 30% class A bonds at a 50 basis point spread; and 20% class BBB bonds at an 80 basis point spread. The target rating for the benchmark and/or fund is a score of 2.3, with a YTM spread of 48.5 basis points.

At 230A is shown a summary of a pool of new securities issues considered eligible, e.g., on the basis of maturity date and/or other criteria, for potential addition to the benchmark/fund summarized at 220. In the example shown at 230A of FIG. 3A, the mix of all such potentially eligible new bond issues consists of 33.3% class AA bonds with a YTM spread of 35 basis points, 33.3% class A bonds with a YTM spread of 50 basis points, and 33.4% class BBB bonds having a YTM spread of 80 basis points. It may be seen in FIG. 3A that the spreads of the pool of all eligible new-issue bond additions are equal to those of the existing mix. As shown at 232A, however, the average rating score of the eligible additions is 1.99, which is lower (or of lower credit quality) than the defined rating score of 2.30; and the average of YTM spread of the proposed additions is 55 points, which is greater than the initially-defined minimum of 48.5 points. Thus it might be deemed inadvisable, according to pre-determined logic rules, not to add the entire pool of eligible securities, as for example such changes in rating score and YTM spread may be deemed to materially change the quality, saleability, or other characteristic of the benchmark and/or fund.

Alternatively, if at 230A the eligible new issues have significantly higher credit quality (e.g., if they consist largely of bonds with AAA ratings), they might not be added to the fund or benchmark, as in many circumstances this might be expected to materially lower the YTM of an existing portfolio.

In the example shown at 230B, it is proposed to add a mix of new bond issues consisting of 64% class AA bonds, with a YTM spread of 35 basis points, and 36% class BBB bonds having a YTM spread of 80 basis points. Note that the spreads of the proposed new-issue bond additions are equal to those of the existing mix. As shown at 232, the average rating score of the proposed additions is 2.2872, which may be deemed sufficiently similar to the defined rating score of 2.300, as lying within a suitable pre-determined tolerance; and the average of YTM spread of the proposed additions is 51.2 points, which is greater than the initially-defined minimum of 48.5 points.

As noted above, in some circumstances it may be advantageous to restrict consideration of new issues for addition to the benchmark and/or fund defined at 220 to issues having the same maturity date(s), either (a) identically or within a defined range, such as within one or three months; and/or (b) with each other and/or or the maturity dates used to define the benchmark and/or fund at inception (the eligible new issues); and to consider whether addition of the new issue(s) will cause any or all of parameters 215, 217, and/or any other desired parameters to (a) remain the same (absolutely or within one or more predetermined tolerance ranges); (b) increase (optionally within a tolerance), or (c) decrease (optionally within a tolerance. The projected result of addition of such issue(s) 232A can be compared with criteria (i.e., conditions) specified for example in summary 220, and a determination made whether to add or not to add the new issues, add a portion of the new issues, reweight existing issues or remove an existing issue from the benchmark and/or the fund.

It may be seen at 230B the pool of issues selected for addition to the benchmark and/or fund has a similar average credit rating to that of the established benchmark/fund, and an average YTM spread above that of the current portfolio summarized at 220, while as shown at 230A the pool of all potentially eligible issues has a significantly lower average rating.

At 240, it may be seen that the addition of the selected issues shown at 230B results in a benchmark and/or fund which consist of 51.4% class AA bonds, having a YTM spread of 35 points, 27.0% class A bonds having a YTM spread of 50 points, and 21.6% class BBB bonds having a YTM spread of 80 points. As shown at 242, the average rating of the proposed updated benchmark and/or fund is 2.296, which is similar, or within a pre-defined tolerance, of the minimum of 2.300; and the average of YTM spread of the proposed updated benchmark and/or fund is 48.77 points, which is greater than the initially-defined minimum of 48.5 points.

Presuming that requirement(s) for maintenance of an similar or minimum rating score and/or a similar or higher YTM spread has been imposed on the benchmark and/or fund (i.e., that improvement in both rating score and YTM spread are acceptable), the proposed additional issues may be added to the benchmark and/or fund, with resultant characteristics as shown.

Thus logic used to control the one or more processor(s) of system 110 may cause the processors to add the proposed mix to the benchmark or fund by (a) generating and storing data representing the amended set of issues included in the benchmark or fund, and (b) generating and storing new data representing the amended or updated benchmark/fund parameters. In addition, signals indicating that an amended or updated fund or benchmark has been created can be provided to any of systems 112, 114, 116, so that shares in the amended or updated fund may be offered in primary or secondary market exchanges.

Another example of a process of addition of new issues of bonds to a benchmark and/or fund is shown in FIG. 3B. In the example of FIG. 3B, addition of the new issues results in a shift of percentages between classes, but the collective maturity date is maintained without change, while rating score remains acceptably consistent with the 2.300 benchmark at 2.295, and YTM spread increases from 24.50 to 24.53.

Depending upon the stated goals/requirements of the benchmark and/or fund summarized at 220, 230, 240, logic representing conditional rebalancing rules associated with the benchmark and/or fund may be applied to allow further new-issue additions, so long as the rating score and YTM spread shown at 242 do not drop below originally-defined levels shown at 227, 230, or other specified level(s); or so long as any other pre-defined criteria are satisfied.

Following addition of any new bond issues, shares or other units of a fund may be offered, by fund system(s) 110, exhange(s) 116, and/or any other agents, for the same or a different price in either the primary or secondary markets. As will be appreciated by those skilled in the arts, any electronic trading platform suitable for the purpose may be used for offering and/or completing transactions in shares or units of funds defined in accordance with this disclosure.

For example, upon conditioned rebalancing of a fund defninition by a system 110, data representing the rebalanced fund may be transmitted or otherwise made available to one or more exchanges 116. Such data may include an identifier of the fund, a quantity of shares in the fund available for buying and/or selling via the exchange, and one or more price terms to be used in executing transactions in the fund. The target exchange(s) may be primary or secondary market exchanges; and transmission of orders may constitute either firm bids/offers or invitations to bid or to negotiate. Thereafter users of one or more systems 112 may interact with the exchange(s) 116 to purchase all or some portion of the shares of the fund offered on the exchange, a posted or negotiated price.

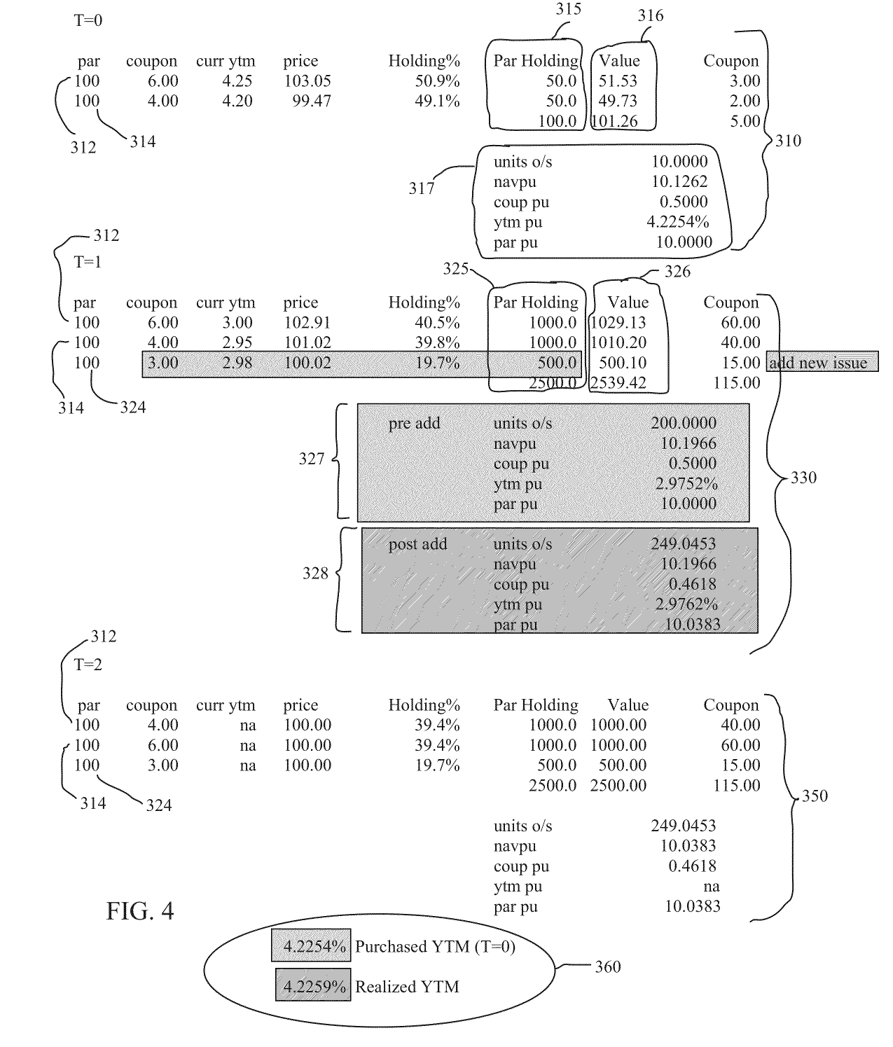

An example of data generated through application of processes and logic rules in accordance with the disclosure is illustrated in FIG. 4. The information in FIG. 4 represents, for example, a possible output, via paper or an interactive display screen, summarizing the effect of processes described herein.

At 310, data generated by a processor 110 representing a summary of a fund established in accordance with the disclosure are provided, as for example on an output screen of a computer workstation communicatively linked to server/system 110. The data indicates that, as established (at “T=0”), the fund comprises securities of two distinct issues, identified as buckets 312, 314.

At 312 data shoing that issue bucket comprises securities of an issue having a par value of $100.00 per unit, with coupon payments of $6.00 (6%) each and a current YTM projection of 4.25 percent, are displayed. A price of $103.05 was paid for each unit. Units of issue bucket 312 make up 50.9% of the fund, as initially established, by price; and 50.0% by par value.

Data presented at 314 indicate that issue bucket 314 comprises securities of an issue having a par value of $100.00 per unit, with coupon payments of $4.00 (4%) each and a current YTM projection of 4.20 percent. A price of $99.47 was paid for each unit. Units of issue bucket 314 make up 49.1% of the fund, as initially established, by price; and 50.0% by par value.

Data displayed at 315 indicate that the fund, as established, comprises quantities of each issue amounting to $50.00 par value; at 316 it is shown that that purchase price attributable to the portion of the bucket 312 issues included in the fund was $51.53; the price attributable to bucket 314 issues was $49.73.

At 317 a summary of fund unit characteristics at the time of fund establishment is provided. The holdings of the fund are divided amongst 10 outstanding units (“unit o/s”); each unit having an effective paid purchase price (“navpu”) of $10.1262), anticipated coupon payments (“coup pu”) of $0.50, current expected YTM (ytm pu”) of 4.2254%, and a par value (“par pu”) of $10.0000.

At 330 a summary of the same fund at a later time (denoted “T=1”) is provided. At 325 it is seen that at time T=1 the fund has been expanded to comprise quantities of each of the issues of buckets 312 and 314 amounting to $1000.00 par value; at 326 it is shown that that purchase price attributable to the bucket 312 issues included in the fund was $1029.13; the price attributable to bucket 314 issues was $1010.20.

At time T=1 a new issue has been added to the fund as bucket 324. The security of bucket 324 has a maturity date, credit rating, and optionally other characteristics compatible with the definition of the fund, and like those of buckets 312, 314, a par value of $100.00. The issue of bucket has coupon payments of $3.00 (3%). At time T=1 the current expected YTM of bucket 312 issues is $3.00; of bucket 314 issues, $2.95; and of bucket 324 issues, $2.98. The market purchase/sale price of bucket 312 issues is $102.91; of bucket 314 issues, $101.02; and of bucket 324 issues $100.02.

At 325 it is indicated that, upon addition of bucket 324 issues, the fund comprises units of bucket 312 and 314 issues having a par value of $1000.00 each, and $500.00 par value of bucket 324 issues.

At 327 it is shown that at time T=1, prior to addition of bucket 324 issues, the fund consists of 200 units, each unit having a market purchase/sale price (“navpu”) of $10.1966), coupon payment value (“coup pu”) of $0.50, expected YTM (ytm pu”) of 2.9752%, and a par value (“par pu”) of $10.0000.

At 328 it is shown that at time T=1, subsequent to addition of bucket 324 issues, the fund consists of 249.0453 units, each unit having a market purchase/sale price (“navpu”) of $10.1966), coupon payment value (“coup pu”) of $0.4618, expected YTM (ytm pu”) of 2.9762%, and a par value (“par pu”) of $10.0383.

Thus it is seen that addition of the bucket 324 issues at time T=1 has a relatively small, but positive, effect on current YTM. In other words, the addition of bucket 324 issues at time T=1 can be considered to have no significant effect on YTM, or an effect within a pre-defined or predetermined limit or threshold.

At 350 a summary of the fund at the maturity date (denoted T=2) is provided. At maturity, the fund comprises the same three issue buckets 312, 314, 324 as at time T=1. The fund, and each of its issues, having matured, YTM for all issues is n/a.

At 360, the performance of the fund as established, had bucket 324 issues not be added to the fund, is compared to the performance of the fund following addition of bucket 324 issues at time T=1. Had the bucket 324 issues not been added, the fund would have realized a YTM of 4.2254%. With inclusion of the bucket 324 issues, the fund would have realized a YTM of 4.2259%.

Thus it may be seen that matching of the maturity date and YTM (identically or within limits) of new issues to those of an established fund, as of the time of addition can selectively maintain or enhance performance of a fund during the remaining common term of the issues that make up the fund, while maintaining credit rating and other characteristics.

It may be seen also that the disclosure provides systems, methods, and stored, machine-readable media comprising coded instructions for processing signals to generate machine-readable data sets representing parameters of exhange-traded funds. Such systems 110, methods, and media may be configured to cause least one processor to access data representing a plurality of aggregated characteristics of a plurality of financial interests to be included in an exchange-traded fund; access data representing characteristics of each of a plurality of electronically-tradeable interests; determine, for each of said plurality of electronically-tradeable interests, a corresponding effect that inclusion of a quantity of the electronically-tradeable interest would have on at least one of said aggregated characteristics; if, with respect to each of said plurality of electronically-tradeable interests, the corresponding effect is not larger than at least one limit, generate data associating said quantity of said electronically-tradeable interest with the exchange-traded fund; and store the generated data in non-transient memory, such as data store 130 and/or volatile memory accessible by the processor. The aggregated characteristics of such funds, and corresponding benchmarks, can represent one or more quantity-weighted averages characteristic of the plurality of electronically-tradeable financial interests.

Absolute values of limits according to such aspects of the disclosure may be greater than or equal to zero.

Systems according to such aspects of the disclosure may further be configured to receive, via a communications network, signals representing an order for execution of a trade comprising a portion of the electronically-traded fund; generate signals confirming execution of at least a portion of the ordered trade; and store signals confirming execution of the executed portion of the trade in non-transient machine readable memory accessible by the at least one processor.

As noted above, in various embodiments, some or all of components 110, 112, 114 of FIG. 1 may be combined, and/or otherwise configured to implement multiple programming or other machine instruction applications running on single machines, or a wide variety of other distributed processing schemes may be employed.

System(s) 110, 112, 114 can each comprise any one or more data processor(s), computer(s), and/or other system(s) or device(s), and necessary or desirable input/output, communications, control, operating system, and other devices, including software, that are suitable for accomplishing the purposes described herein. For example, a general-purpose data processor provided on one or more circuit boards, as provided by Intel, IBM, Compaq, and a number of other producers, using a UNIX, Apple, or Microsoft general-purpose operating system and suitable navigation application software programs, will suffice. A large number of suitable devices, including many adapted for long-term exposure to corrosive environments, are now available and will doubtless hereafter be conceived and developed. The selection of suitable components to serve as and/or with processors 110, 112, 114, including support and control components and software, in accordance with the invention, will not present difficulty to those of ordinary skill in the art once they have been made familiar with this disclosure.

Data processes used in implementing the disclosure, and logic rules used to describe and implement them, can be implemented in any programming or other instruction schemes (including high- and/or low-level programming languages) and data structures consistent with the purposes disclosed or suggested herein.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

Those skilled in the relevant arts will recognize that, while aspects of the disclosure provided in this application relate to the holding, transfer, and/or administration of securities and other financial interests, both preferred and practical applications of means for enabling such holdings, transfers, sales, and/or administration implementations will require the use of specially-adapted data processing and electronics communications systems, as described herein.

The scope of the invention is to be defined solely by the appended claims, giving due consideration to the doctrine of equivalents and related doctrines.

What is claimed is:

1. A system for processing signals to generate machine-readable data sets representing parameters of exchange-traded funds, the system comprising at least one processor configured to:
access data representing a plurality of aggregated characteristics of a plurality of financial interests to be included in an exchange-traded fund and/or fixed income benchmark index;
access data representing characteristics of each of a plurality of electronically-tradeable interests;
determine, for each of said plurality of electronically-tradeable interests, a corresponding effect that inclusion of a quantity of the electronically-tradeable interest would have on at least one of said aggregated characteristics;
if, with respect to each of said plurality of electronically-tradeable interests, the corresponding effect is not larger than at least one limit, generate data associating said quantity of said electronically-tradeable interest with the exchange-traded fund and/or fixed income benchmark index; and
store the generated data in non-transient memory accessible by at least the at least one processor.

2. The system of claim 1, wherein at least one of the aggregated characteristics represents a quantity-weighted average characteristic of the plurality of electronically-tradeable financial interests.

3. The system of claim 1, wherein an absolute value of said at least one limit is greater than zero.

4. The system of claim 3, wherein at least one of said limits represents a change in a relative quantity of the corresponding electronically-tradeable interest to be associated with the exchange-traded fund and/or fixed income benchmark index.

5. The system of claim 1, wherein the non-transient memory is accessible by at least one electronic exhange via a communications network.

6. The system of claim 1, wherein the generated data is pushed to at least one electronic exchange via a communications network.

7. The system of claim 1, wherein the plurality of electronically-tradeable interests represent bonds, and the characteristics thereof comprise at least one of an interest rate, a coupon payment, a yield to maturity, and a maturity date.

8. The system of claim 1, wherein the plurality of electronically-tradeable interests represent bonds, and the characteristics thereof comprise at least one of a credit rating, a duration, and a convexity.

9. The system of claim 1, wherein the at least one processor is further configured to:
receive, via a communications network, signals representing an order for execution of a trade comprising a portion of the exchange-traded fund and/or fixed income benchmark index;
generate signals confirming execution of at least a portion of the ordered trade; and
store signals confirming execution of the executed portion of the trade in non-transient machine readable memory accessible by the at least one processor.

10. The system of claim 9, wherein the at least one processor is further configured to send, via the same or another communications network, signals confirming execution of executed portion of the ordered trade.

11. Media comprising stored, machine-readable data representing instructions configured to cause a computer processor to:
access data representing a plurality of aggregated characteristics of a plurality of financial interests to be included in an exchange-traded fund and/or fixed income benchmark index;
access data representing characteristics of each of a plurality of electronically-tradeable interests;
determine, for each of said plurality of electronically-tradeable interests, a corresponding effect that inclusion of a quantity of the electronically-tradeable interest would have on at least one of said aggregated characteristics;
if, with respect to each of said plurality of electronically-tradeable interests, the corresponding effect is not larger than at least one limit, generate data associating said quantity of said electronically-tradeable interest with the exchange-traded fund and/or fixed income benchmark index; and
store the generated data in non-transient memory accessible by at least the at least one processor.

12. The media of claim 11, wherein at least one of the aggregated characteristics represents a quantity-weighted average characteristic of the plurality of electronically-tradeable financial interests.

13. The media of claim 11 wherein an absolute value of said at least one limit is greater than zero.

14. The media of claim 13, wherein at least one of said limits represents a change in a relative quantity of the corresponding electronically-tradeable interest to be associated with the exchange-traded fund and/or fixed income benchmark index.

15. The media of claim 11, wherein the non-transient memory is accessible by at least one electronic exhange via a communications network.

16. The media of claim 11, wherein the generated data is pushed to at least one electronic exchange via a communications network.

17. The media of claim 11, wherein the plurality of electronically-tradeable interests represent bonds, and the characteristics thereof comprise at least one of an interest rate, a coupon payment, a yield to maturity, and a maturity date.

18. The media of claim 11, wherein the plurality of electronically-tradeable interests represent bonds, and the characteristics thereof comprise at least one of a credit rating, duration and a convexity.

19. The media of claim 11, wherein the at least one processor is further configured to:
receive, via a communications network, signals representing an order for execution of a trade comprising a portion of the exchange-traded fund and/or fixed income benchmark index;
generate signals confirming execution of at least a portion of the ordered trade; and
store signals confirming execution of the executed portion of the trade in non-transient machine readable memory accessible by the at least one processor.

20. The media of claim 19, wherein at least one processor is further configured to send, via the same or another communications network, signals confirming execution of executed portion of the ordered trade.
